(19) United States
(12) Patent Application Publication
(10) Pub. No.: US 2009/0208393 A1
(43) Pub. Date: Aug. 20, 2009

(54) DEVICE FOR REMOVING HARMFUL CONSTITUENTS FROM EXHAUST GASES OF INTERNAL COMBUSTION ENGINES

(75) Inventors: Lothar Wenzel, Hachenburg (DE); Bernhard Nibbrig, Haundorf/Obererlenbach (DE)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Lothar Wenzel, Hachenburg (DE)

(21) Appl. No.: 11/912,883

(22) PCT Filed: Sep. 15, 2006
(86) PCT No.: PCT/DE2006/001644

§ 371 Date: Feb. 19, 2009

(30) Foreign Application Priority Data
Sep. 16, 2005 (DE) 10 2005 044 494.6

(51) Int. Cl. B01D 53/94

(52) U.S. Cl. 423/213.2; 422/171; 423/212

(57) ABSTRACT

A device for removing harmful constituents from exhaust gases of internal combustion engines comprises a first housing for conducting exhaust gases, the first housing containing a front, middle, and rear area with at least one intake in the front area and at least one outlet in the rear area. A first structure containing a plurality of contiguous cavities covers the cross-section of the first housing at least partially. The following are disposed in the housing in any sequence: a second structure which contains and/or is coated with a first metal oxide; a third structure which contains and/or is coated with a catalyst for converting or degrading contaminants; and a fourth structure which contains and/or is coated with a second metal oxide. The first housing contains or is at least partially made of or coated with porous aluminum oxide, mullite, cordierite, silicon nitride, tialite, steatite, zircon, zircon dioxide and/or silicon carbide.

### BACKGROUND

The present application relates to a device for removing harmful constituents from exhaust gases of internal combustion engines, in particular diesel engines.

For quite some time now there has been major interest in removing harmful constituents from exhaust gases of internal combustion engines for obvious reasons. It is known that sulphurous residue, carbon monoxide, polycyclic aromatic compounds, and soot particles can injure humans and damage the environment long-term. A plurality of methods and devices for reducing contaminants in exhaust gases are known in the art. The effect of more recent efforts has been to remove waste gases and contaminants from diesel engines even more thoroughly and efficiently, for example, soot particles, which bind organic residue, such as hydrocarbons.

For example, the accrual of nitrogen oxides (NOx) can be minimized using exhaust gas recirculation, as described in DE 699 06 586 T2. Exhaust gas is removed from the outlet manifold generally via an exhaust gas recirculation valve and is mixed in with the charged air (fresh gas), causing the combustion temperature to be lowered. As a result, the amount of NOx is reduced. Since the amount of oxygen in the exhaust gas also drops, the proportions of carbon monoxide, unburned hydrocarbons, and soot can increase with less than optimal settings.

Using selective catalytic reduction (SCR) technology, nitrogen oxide can be reduced to nitrogen with a suitable catalyst in the presence of ammonia. Ammonia is obtained from urea in a catalyst plant, and in the form of an aqueous solution, it can be constantly carried along with the vehicle and metered in required quantities. WO 96/36797 describes mixing an aqueous urea solution with compressed air in a mixing chamber, and then spraying the solution into the exhaust gas current via an atomizing nozzle positioned in the exhaust gas flow. SCR catalysts are generally based on an element selected from the group Pt, Pd, Rh, Ir, Au, Ag, and Ru. Details on the use of SCR catalysts are also described in DE 197 49 607 C1, DE 103 48 799 A1, and DE 102 57 113 A1.

In general, the temperature in exhaust gas plants of diesel combustion engines is not high enough to promptly burn filtered soot particles, even if present on a suitable catalyst surface. To avoid clogging a filter and to minimize soot proportions in the exhaust gases, accumulated soot particles have to be periodically combusted. The temperature required for combusting soot with oxygen from exhaust gas is approximately 500 to 600° C. A temporary rise in temperature can be produced by injecting an additive, for example a cerium additive, as described in DE 100 20 170 C1. Though the proportion of soot can be noticeably lowered in this way, there are always significant amounts of additive residues remaining in the filter system. This type of periodic regenerating can also be conducted by interpolating an oxidation catalyst, to which unsaturated or unburned hydrocarbons can be fed, i.e., by subsequent injection (see, for example, DE 103 21 105 A1). Instead of raising the temperature sporadically to the combustion temperature of soot by adding in additives or fuel, DE 101 03 771 A1 proposes collecting soot particles and hydrocarbons on the surface of an oxidation catalyst, so that a rise in temperature to 450° C. would be sufficient to eliminate such residue. According to DE 101 03 771 A1, this temperature can be precipitated by external heating. DE 197 48 561 A1 discloses an electric heating element for this very purpose.

The continuous regenerating of particle filters can be carried out according to the so-called Continuous Regeneration Trap (CRT) method, as described in DE 199 55 324 A1 DE 103 21 105 A1. An oxidation catalyst is connected upstream of the particle filter in the exhaust gas line, which oxidizes the nitrogen oxide (NO) contained in the exhaust gas into nitrogen dioxide, which is then used for oxidizing carbon monoxide or soot. With this technology, there is naturally a problem of minimizing the proportion of NOx in the eliminated exhaust gases.

Suitable soot particle filters are made regularly from high-temperature oxide ceramics or silicon carbide according to DE 103 48 799 A1.

The problem of exhaust gas purification has not yet been satisfactorily solved because the interactions between the components to be removed are very complex. Contaminants such as carbon monoxide, hydrocarbons, and soot are to be rendered harmless by means of oxidation. In addition, nitrogen oxides are to be eliminated only by means of reduction. Furthermore, if soot is combusted at its usual combustion temperature of approximately 500 to 600° C., the materials used for exhaust gas plants can be irreparably damaged.

### SUMMARY

The present application provides a device for removing contaminants from internal combustion engines, which is not affected by the drawbacks of the prior art, and which provides continuous combustion of filter red soot particles without the need for continuous or periodic addition of additives or fuel.

A device for removing harmful constituents such as soot from exhaust gases of internal combustion engines, in particular diesel engines, is described herein. In one embodiment, the device comprises a first housing, suitable for conducting exhaust gases, with at least one intake and at least one outlet and contains a front, middle, and rear area, whereby there is at least one intake, for example, in the front area, and at least one outlet, for example, in the rear area. In the front area, there is at least one first structure containing a plurality of contiguous cavities that covers a cross-section of the first housing at least partially, and preferably completely, upon which the following are arranged in the housing in any order: at least one second structure covering the cross-section of the first housing at least partially, and preferably completely, that contains a plurality of contiguous cavities, and which contains at least one first metal oxide and/or is coated with the at least one first metal oxide at least partially; at least one third structure covering the cross-section of the first housing at least partially, and preferably completely, that contains a plurality of contiguous cavities, and which contains at least one catalyst for converting or degrading contaminants, in particular an oxidation catalyst, and/or is coated with the at least one catalyst at least partially; and at least one fourth structure covering the cross-section of the first housing at least partially, and preferably completely, containing a plurality of contiguous cavities, and which contains at least one second metal oxide and/or is coated with the at least one second metal oxide at least partially, whereby the first housing is made at least in sections of, and/or the inner walls of the housing are made at least partially of aluminum oxide, mullite, cordierite, silicon nitride, tialite, steatite, zircon, zircon dioxide, and/or silicon carbide, or is coated with aluminum oxide, mullite, cordierite, silicon nitride, tialite, steatite, zircon, zircon dioxide, and/or silicon carbide. In a preferred embodiment, a section or an inner wall of the first housing is made at least partially of porous aluminum oxide, mullite, cordierite, silicon nitride, tialite, steatite, zircon, zircon dioxide and/or silicon carbide, or is coated with porous aluminum oxide, mullite, cordierite, silicon nitride, tialite, steatite, zircon, zircon dioxide and/or silicon carbide.

In one embodiment, the first housing comprises preferably at least one first, at least one second, at least one third, and at least one fourth structure, in the direction from the intake to the outlet.

In one embodiment, the first housing of the device is preferably either a porous silicon carbide housing, or is coated on the inner walls with porous silicon carbide. It is sufficient if the inner walls of the first housing are coated up to more than 50% with silicon carbide, though such housings are preferably used which have inner walls coated completely almost completely with silicon carbide. For protection from damage the first housing can also have an outer sheathing of metal. This metallic outer sheathing is preferably made of, or preferably coated with, zinc plate or steel, in particular Cr/Ni steel.

In one embodiment, silicon carbide may also include carbon fiber-reinforced silicon carbide (C/SiC). Carbon fiber-reinforced silicon carbide has extremely good heat conductivity and is distinguished by high thermoshock strength. Also, its density and porosity can be adjusted to suite requirements during manufacture. A description can be found in DE 198 58 197 A1, which is hereby incorporated by reference.

In one embodiment, the silicon carbide may also include additives of inorganic binders, in particular clay, zircon silicate, zircon dioxide, and/or aluminum oxide, and/or organic binders, in particular in the form of an addition of soot, which can be added during the manufacturing process.

Suitable silicon carbide forms can be obtained, for example, from one preliminary sludge step. This can be an aqueous dispersion which, in addition to silicon carbide, contains ground additives of organic binders such as soot, inorganic binders such as clay and, if required, surfactants. Suitable clay-binders include, e.g., kaolinite, halloysite, serpentine, muscovite, illite, talc, vermiculite, montmorillonite, beidelite, smectite, saponite, and hectorite. Alternatively, or in addition to soot, various synthetic or semi-synthetic polymers are also considered organic binders, such as polyvinyl alcohol, polyvinyl butyrate, cellulose, or cellulose derivatives and, in particular, starch products such as those described in DE 44 00 131 A1, which is hereby incorporated by reference. Silicon carbide molded items can be obtained from slurry casting, film casting, pressure molding, or extrusion. For example, an aqueous slurry dispersion can be cast in a plaster mold. The silicon carbide raw mass is then removed and forwarded to a sintering process, after the dispersion water has been removed from the plaster mold. At temperatures of the sintering process, the organic or inorganic binders inside the silicon carbide molded item often form a substantially contiguous structure further strengthening the molded item.

In one embodiment, the coating material of the first housing or the housing material has open pores.

In one embodiment, the housing walls or the inner coating of the walls, in particular those containing porous silicon carbide, contribute to preventing any deposits. Housing walls configured in this way also contribute to the observed advantageous flow properties. It is also helpful with the construction of the inventive devices that the above-described first housings, in particular first housings containing silicon carbide, exhibit barely any or no thermal expansion and, as a result, come up to requested dimensions.

Materials and molded items such as those known from pore burner technology are preferably used for the first structure present in the front area of the housing. These are mostly structures with spatially contiguous cavities, which can be used to form a defined flame zone. In addition, the desired flow profile can be adjusted precisely and extensively with these pore burner structures. Embodiments of such known pore burners are described in U.S. Pat. No. 5,522,723, WO 95/01532, DE 199 39 951 A1, and DE 199 04 921 C2. Suitable porous pore burner materials can also be obtained from loosely layered, granular bulk material, that is subjected to a sintering process. This is described in EP 0 840 061 A1 and DE 2 211 297 OS. In this context, sintered metal powder is likewise considered. Knitted metallic wire fabrics are also suitable, as well as foam ceramics and metal foams or sponges, such as those described in DE 10 2004 006 824 A1 and DE 198 04 267 A1. The porous material of the first structure can also be based on aluminum oxide or silicon carbide ceramic, as described in DE 102 28 411 C1.

In a preferred embodiment, the first structure comprises a knitted metallic wire fabric, an open-cell foam ceramic based, for example, on silicon carbide, or an open-cell metallic foam, which preferably contains a so-called washcoat coating, comprising oxides of aluminum, titanium, zirconium, iron, nickel, germanium, barium, hafnium, and/or oxides of rare earth metals, such as lanthanum oxide and cerium oxide. Titanium dioxide and aluminum oxides as well as their mixtures are particularly preferred as coating materials. Alternatively, or in addition, a coating can be effected with phosphoric acid.

In one embodiment, the cavities or pores in the first structure generally have a size adequate for admitting to the first housing particulate exhaust gas constituents such as soot particles. The porosity is, for example, in the range of 5 to 35 ppi (pores per inch), and in particular in some embodiments 10 to 25 ppi. In one embodiment, the porosity of the first structure is approximately 20 ppi. By arranging the first structure as described above, the incoming exhaust gas flows through the exhaust gas purification device in laminar fashion into the front area of the housing, i.e., onto the intake. Transverse flows impairing the purification of the exhaust gas are stopped completely from the outset. For this reason there is no resulting deposit of soot particles or other contaminants on the inner walls of the housing or on the first structure.

The second structure is preferably based on an open-cell foam ceramic, a knitted wire fabric, or an open-cell metallic foam. It effectively likewise covers the entire cross-section of the first housing and extends to the inner walls. Incorporated into this second structure, for example in the form of a coating, is at least one first metal oxide, if required in combination with a metal from the platinum group such as Pt, Rh, Pd, Ir, Os, and Ru. Suitable first metal oxides include lithium oxide, barium oxide, titanium oxide, cerium oxide, manganese oxide, zircon oxide, magnesium oxide, lithium, sodium, potassium, silver and cerium vanadate, vanadate oxide/alkali metal oxide combinations, and perrhenate. Cerium/zircon mixed oxides are likewise suitable. In a preferred embodiment, the second structure contains at least one vanadate, in particular silver and/or potassium vanadate, and/or is coated with at least one vanadate, in particular silver and/or potassium vanadate. Potassium vanadate is particularly preferred. The second structure contributes to the elimination of soot.

In a preferred embodiment, the coating of the second structure includes, in addition to a first metal oxide such as potassium vanadate, a metal nitrate, for example an alkali or earth alkali nitrate such as sodium, lithium, potassium, barium, calcium, magnesium, and strontium nitrate, and/or a compound based on a water glass compound such as sodium and potassium silicates, in particular natron water glass.

In one embodiment, the proportion of coating relative to the total weight of the second structure is preferably in the range of 0.01 to 10% by weight, preferably in the range of 0.1 to 5% by weight.

In one embodiment, the porosity of the second structure is preferably in the range of 5 to 40 ppi, preferably from 10 to 35 ppi. Suitable porosities are, for example, also in the range of 10 to 20 ppi. In one embodiment, the porosity of the second structure is approximately 20 ppi.

In a preferred embodiment, the first housing, in particular the middle area of this housing, comprises at least two sequential coated second structures, which may be separated by an interstice.

The third structure is preferably in the form of an open-cell foam ceramic, preferably made of silicon carbide, of a knitted wire fabric, or preferably of an open-cell metallic foam that extends over the entire cross-sectional area of the first housing. This structure has a catalyst that supports oxidation of constituents of the streamed exhaust gas by means of the oxygen still contained in the exhaust gas. A particularly good purification effect is also achieved by the third structure containing a catalyst, selected from the group of palladium, rhodium, and/or silver, and/or is coated with a catalyst, selected from the group of palladium, rhodium, and/or silver. If the catalyst also contains at least minimal traces of iron, nickel, iron oxide, in particular Fe₂O₃ and Fe₃O₄, the cleaning result can be further optimized. Iron oxides are particularly suited as additives. Residue of carbon monoxide, hydrocarbons, or other oxidizable harmful constituents can be completely or almost completely eliminated from the exhaust gas of the internal combustion engine. In another embodiment, the coating or the catalyst of the third structure further contains at least one metal nitrate, for example, an alkali or earth alkali nitrate, such as potassium nitrate, and/or a compound based on a water glass compound such as sodium or potassium silicates, in particular sodium water glass.

In one embodiment, the third structure is preferably pre-coated with a washcoat. Suitable washcoat coatings include, for example, oxides of aluminum, titanium, zirconium, hafnium, oxides of alkali, and earth alkali metals such as barium oxide or magnesium oxide, and/or oxides of lanthanoids, or respectively rare earth metals such as lanthanum oxide, praseodymium oxide, terbium oxide, ytterbium oxide, samarium oxide, gadolinium oxide, or cerium oxide. Titanium dioxide or respectively aluminum oxides are particularly preferred as coating materials. Alternatively, or in addition, a coating with phosphoric acid can be applied.

In one embodiment, the open-cell third structure preferably has cell widths of 6 to 50 ppi, in particular from 20 to 45 ppi. Suitable porosities are, for example, also in the range of 20 to 40 ppi. In one embodiment, the porosity of the third structure is approximately 40 ppi.

To the extent that soot particles or hydrocarbons have not been combusted or oxidized when the exhaust gas is conveyed through the first housing to the third structure, they are transformed into carbon dioxide by a fourth structure, preferably separated by an interstice from the third structure. The fourth structure is preferably a knitted metallic wire mesh, an open-pore foam ceramic, preferably based on silicon carbide, or in particular an open-cell metallic foam. The fourth structure preferably covers, as it does the first, second, and third structure, the entire cross-section of the first housing, however, in contrast to the first, second, and third structure, the fourth structure is preferably housed in the rear area of the first housing. The fourth structure has at least one second metal oxide such as wolfram oxide, silicon oxide, titanium dioxide, boron oxide, aluminum oxide, zircon oxide, in particular containing lanthanum, barium oxide, magnesium/aluminum mixed oxide, and/or silicon/aluminum mixed oxide, or is coated with it. Aluminum oxide is particularly preferred as a second metal oxide. In a preferred embodiment apart from the second metal oxide, such as aluminum oxide, at least one rare earth metal oxide such as yttrium oxide, praseodymium oxide, terbium oxide, gadolinium oxide, lanthanum oxide, samarium oxide, ytterbium oxide, or cerium oxide. Cerium oxide is particularly preferred. Apart from cerium oxide, the rare earth metal oxide lanthanum oxide can also be used, either alternatively or in addition.

In a further preferred embodiment, there are also zeolites in or on the fourth structure, apart from the second metal oxide, in particular aluminum oxide, especially in combination with at least one rare earth metal oxide, in particular cerium oxide. With the inventive device described herein, it is possible to maintain a temperature in the range of 300 to 450° C. between the third and fourth structure. These temperatures are adequate under the circumstances for breaking down soot and/or hydrocarbons on the fourth structure.

In one embodiment, the porosity of the fourth structure can be, for example, in the range of 10 to 65 ppi, in particular 15 to 60 ppi. In one embodiment, the porosity of the fourth structure is approximately 50 ppi.

In a further embodiment of the inventive device described herein, there is at least one fifth structure, containing a plurality of contiguous cavities, in the first housing, which preferably completely covers the cross-section of this housing at least in areas. The basic body of this fifth structure is preferably structured similar to the first to fourth structures and is preferably in the form of an open-cell foam ceramic, a knitted metallic wire fabric, or preferably an open-cell metallic foam. This fifth structure contains and/or is at least partially coated with platinum and/or rhodium as catalyst. This coating can further contain, for example, also in the form of a V or coating as washcoat, titanium dioxide, zircon oxide, silicon dioxide, aluminum oxide, and/or aluminum silicate. In one embodiment, a catalyst mixture containing platinum and rhodium is used and has proven particularly effective. In a preferred embodiment, the weight ratio of platinum to rhodium is set in the range of 10:1 to 1:10, in particular in the range of 6:1 to 1.5:1, and preferably in a ratio of approximately 4:1. The fifth structure is preferably arranged between the first and second structure. The fifth structure is preferably disposed near the first structure, i.e., without leaving an interstice.

In a further embodiment of the inventive device, there is at least one further sixth structure, containing a plurality of contiguous cavities, in the first housing, which covers the cross-section of the housing at least in areas, and preferably completely. The sixth structure preferably comprises a knitted metallic wire fabric and preferably a metallic foam. Alternatively, this structure can also be based on a ceramic foam or other known carrier materials or respectively structures. The sixth structure contains a so-called SCR catalyst and/or is coated with this at least partially. SCR catalysts for reduction of nitrogen oxides in exhaust gas to nitrogen with ammonia as reduction agent, which is generally produced in the plant from urea in solution, are adequately known in the art. These can be, for example, platinum, vanadium oxide, iron oxide, copper oxide, manganese oxide, chromium oxide, or molybdenum oxide, preferably applied to a carrier on aluminum oxide or titanium oxide. By way of example, reference is made to DE 102 57 113 A1, EP 0 376 025 B1, EP 0 385 164 B1, and EP 1 321 641 B1. The sixth structure can be in an embodiment together with the fourth structure as a common, unified structure.

Insofar as the first to sixth structures are to be coated, either with an interim coating, e.g., in the form of a washcoat, or with a final coating, all current coating methods such as galvanic or wet-chemical coating or coating by means of sputtering can be employed for this purpose. Wet-chemical variants are preferred. It is generally sufficient if the respective structure is dipped once, preferably at least twice, into a corresponding immersion bath, which contains the coating component in solution, dispersion, or suspension.

The first to sixth, in particular the second to sixth, structure is generally a so-called wall flow filter. Such wall flow filters are usually fitted with a porous open-cell filter wall. In these filter structures, the particles remain mainly on the surface of the filter wall due to adhesion phenomena, or stick inside the filter wall by means of deep filtration.

In one embodiment, the first, second, third, fourth, fifth, and/or sixth structure includes an open-pore or open-cell foam ceramic, an open-pore or open-cell metallic foam, an open-pore or open-cell metallic sponge, a heat-resistant open-pore or open-cell foam synthetic, a wire mesh, and/or sintered bulk material. The first to sixth structures are regularly configured such that a gaseous fluid can penetrate readily through the contiguous cavities or open pores. The first, second, third, fourth, fifth, and/or sixth structures preferably completely cover the cross-section of the housing. These structures are enclosed in the housing interior and in one embodiment are in direct contact with the inner walls of the housing. These structures are also configured such that gases pass through uniformly.

According to a further embodiment, the first, second, and third, and if required, the fifth and/or sixth structure can be made on a unified permeable or porous body, for example, a knitted metallic wire mesh, foam ceramic, or a metallic foam. The individual structures then form discrete zone sections on such a unified body. In an alternative embodiment the first, second, third, and fourth, and if required, the fifth and/or sixth structure can also be made on a unified permeable or porous body, for example, a knitted metallic wire mesh, a foam ceramic, or a metallic foam, as previously described. In one embodiment, this unified structure can be incorporated to fit perfectly in the first housing, whereby free spaces can be provided, preferably in the intake and outlet region. In a preferred embodiment, this unified structure can also have at least one free space or cavity between the third and fourth structure. With respect to the arrangement of the first to sixth structures inside the first housing, the separate structures are herein described.

Open-pore or open-cell ceramics include cordierite, silicate, aluminum oxide, aluminum nitride, aluminum titanate, glass, zircon oxide, silicon carbide, and silicon nitride ceramics. Suitable open-cell foam ceramics include in particular those made of zircon oxide, silicon carbide, silicon nitride, aluminum nitride, mullite (magnesium aluminum silicate and α-aluminum oxide). These ceramics and their manufacture are known in the art. The same applies to metallic foams and sponges.

In one embodiment, suitable metallic foams are preferably developed from chromium/nickel steels or ferrochromium/aluminum alloys. Metallic foams produced based on nitride are generally less suitable.

In one embodiment, steel containing aluminum is used as wire material for the wire body.

Optionally, the first structure, preferably if in the form of knitted metallic wire mesh or metallic foam, can be coated in advance with a solder material, preferably based on aluminum chromium, preferably aluminum chromium nickel.

In a preferred embodiment, the front area of the first housing widens out to the middle area and/or the rear area tapers down to the outlet, preferably conically. In this context, the surface of the first structure, facing the intake, is arched in the direction of the interior of the first housing, and is preferably substantially spherical.

According to one embodiment of the inventive device, the first, second, third, and fourth structure in each case directly follow one another. Alternatively, there can be a first interstice between the first and second structure, a second interstice between adjacent second structures, a third interstice between the second and third structure, a fourth interstice between adjacent third structures, and/or a fifth interstice between the third and fourth structure. The interstices between the individual structures serve primarily as expansions or eddy spaces. In a preferred embodiment, there is a fifth interstice. This fifth interstice is preferably arranged at least partially in the tapering section of the first housing, i.e., in the transition from the middle to the rear area of the first housing.

In one embodiment, the fifth structure is arranged between the first and second structures, in particular following directly from the first structure. According to one embodiment, there can be an interstice between the first structure and the fifth structure and/or between the second structure and the fifth structure, for example, over the entire cross-section of the device. Alternatively, the first and the fifth structure can be arranged as a unified body, i.e., be without interstice, or devoid of interstice as separate structures.

In one embodiment, the sixth structure can be arranged in the direction from the intake to the outlet before and/or after the fourth structure.

In one embodiment, there is no interstice between the fourth and sixth structure, and preferably the fourth and the sixth structure form a unified structure.

In another embodiment, there is an interstice at least between two adjacent, and preferably between all adjacent, structures, that may extend over the entire cross-sectional area of the adjacent structures.

According to a further embodiment, the average distance between adjacent structures, measured along the longitudinal axis in the direction from intake to outlet, is in the range of 5 to 50 mm, in particular in the range of 10 to 40 mm.

In yet another embodiment, the average width of the first and/or second and/or third and/or fourth and/or fifth and/or sixth structure is in the range of 5 to 50 mm, in particular from 10 to 40 mm, as measured along the longitudinal axis in the direction from the intake to the outlet.

In one embodiment, the distance from the intake to the first structure is in the range of 20 to 100 mm, preferably from 30 to 80 mm, and/or the distance from the structure closest to the outlet to the outlet is in the range of 20 to 120 mm, in particular from 30 to 90 mm.

In another embodiment, the average width of the first and/or second and/or third and/or fourth and/or fifth and/or sixth structure is approximately 25 to 35 mm, preferably approximately 30 mm. Generally speaking, the average distance from the intake to the structure closest to the intake is approximately 50 to 70 mm, in particular approximately 60 mm. Furthermore, in a further embodiment, a distance between the structure closest to the outlet structure and the outlet can be from approximately 40 to 90 mm, in particular 50 to 80 mm and particularly 60 to 70 mm.

According to a preferred embodiment, the inventive device has, substantially in sections, an oval or ellipsoid cross-sectional structure. According to a preferred embodiment, the inventive device, in particular above the area where the above-referenced structures are, has an expansion transverse to the longitudinal axis of the device extending from the intake to the outlet in the range of 100 to 400 mm, preferably 150 to 300 mm and particularly preferably 200 to 250 mm and can, for example, have a value of approximately 220 mm. If the cross-section of the above-referenced structures is oval or ellipsoid, the device can have expansion in the range of 100 to 400 mm, preferably 150 to 300 mm and particularly preferably 200 to 250 mm, for example, approximately 220 mm in the direction of the longitudinal axis, and/or the transversal axis can have an expansion in the range of 50 to 300 mm, preferably 70 to 200 mm and particularly preferably 90 to 150 mm, for example, approximately 100 mm.

In one embodiment, the device further includes a second housing, in particular made of metal, in which the first housing is arranged at least partially.

In one embodiment, the intake of the first housing is outside and the outlet of the first housing is inside the second housing.

In one embodiment, the inner walls of the second housing and the outer walls of the first housing are effectively spaced apart at least partially.

At the same time it is preferably provided that there is at least one first connecting element, in particular in the form of a metallic support bearing between the inner walls of the outer, second housing, and the outer walls of the inner, first housing.

Preferably, there is at least one layer between the first connecting element and the outer walls of the first housing containing preferably synthetic mineral fibers such as fireproof ceramic fibers and/or glass fibers. A second connecting element comprising at least one layer, containing preferably synthetic mineral fibers such as fireproof ceramic fibers and/or glass fibers can also be arranged directly between the outer walls of the first housing and the inner walls of the second housing.

The layer containing ceramic fibers can, for example, be a woven layer, a fleece or felt layer, a cast or formed layer, a plate, a molded article, or a paper. Ceramic fibers in terms of the device described herein may likewise comprise fibrous mineral wool. Fibrous mineral wool includes fibrous glass wool and fibrous stone wool. Suitable ceramic fibers are also known under the technical term Refractory Ceramic Fibers (RCF).

The layer containing ceramic fibers preferably also includes clay minerals, in particular layered silicates. Suitable examples of layered silicates are mica, talcum, serpentine and, in particular, vermiculite. In a preferred embodiment, these layers may contain fireproof ceramic fibers and clay minerals, in particular vermiculite in each case between 30 to 70% by weight of ceramic fibers. In a preferred embodiment, the layers further contain organic and/or inorganic binders. A suitable product is available commercially, for example under the brand name XPE® Expanding Mat, made by the company Unifrax GmbH, of Düsseldorf, Germany.

The connecting elements described above dampen vibrations and other mechanical stresses and contribute to a reliable bond between the first and second housing. At least one layer containing ceramic fibers, as described earlier, can also be arranged between the connecting element and the inner walls of the second housing.

In one embodiment, at least one retainer prevents the uninterrupted exit of exhaust gas freed from contaminants. The retainer, preferably a pin diaphragm, is arranged in front of the outlet of the second housing. The retainer preferably has at least a partial graphite coating.

In one embodiment, the entire diffusion area corresponds to the pin diaphragm in approximately the area of the intake of the first housing, via which the exhaust gas to be purified enters the housing.

According to a further embodiment, the inventive device is integrated into an exhaust gas recirculation system (EGRS). This can ensure that following on from the outlet there is at least one recirculation line for recirculating preferably part of the filtered exhaust gas to the engine. The recirculation line can be connected, for example, to an air intake duct for fresh air via a valve array. The mixture of recirculated and fresh air may be adjusted if required via an EGRS regulator, and can then be fed to the air intake opening of an engine.

According to one embodiment, the device described herein further includes at least one lambda probe, at least one first temperature and/or pressure sensor positioned before or on the intake or in the front area of the first housing, and at least one second temperature and/or pressure sensor positioned on or outside the outlet or in the rear area of the first or second housing.

The inventive device described herein for removing harmful constituents from exhaust gases of internal combustion engines allows new vehicles to readily adhere to the limit values for carbon monoxide, nitrogen oxide, hydrocarbons plus nitrogen oxide, and particulate constituents according to the Euro 5 standard. Even in an older private diesel-powered vehicle with an output of approximately 240,000 km, the following measured variables according to RL 70/220/EWG (test cycle MVEG) can be achieved with an inventive device as described herein: HC 0.17 g/km, NOx 0.61 g/km, HC+NOx 0.78 g/km, CO 0.92 g/km, CO₂ 185.15 g/km, and particle 0.035 g/km.

One aspect of the present device is that residue no longer accumulates in the exhaust gas purification apparatus. Rather, soot particles are converted continuously into carbon dioxide. Continuous, active regenerating consequently occurs. Due to the complete and continuous removal of soot residue in the exhaust gas, the inventive device described herein ensures that the difference in pressure between intake and outlet is never greater than 150 mbar and preferably never greater than 100 mbar, which can exclude negative feedback to the engine power. For example, with the inventive device, a difference in pressure between intake and outlet of under 60 mbar, for example, 57 mbar, can readily be achieved. Here the volume cycles can readily be in the range of 10 to 15 l/sec, for example, approximately 12 l/sec. A disadvantageous pressure build-up frequently occurring in known particle filters is unlikely, using the inventive device described herein. As a result, excess fuel consumption is likewise avoided. The “pore burner” located in the front area of the device likewise contributes, in addition to the arrangement of the coated carrier structures and the coating materials. In this way, a laminar flow can be established and maintained, without perceptible transverse currents that would contribute to considerable fluctuations in concentration of the products to be broken down. The inventive device is very simply constructed and can be deployed without serious modifications in any internal combustion engine, for example, in the exhaust gas plants of ships, private vehicles, trucks, stationary combustion units, and tractors. Also, the device has a highly compact housing form so that it can be integrated into any exhaust gas plants, and retrofitting is relatively straightforward. For eliminating soot particles, a temperature profile may be set using the inventive device, according to which the temperature in the rear area is higher than in the front area. In addition, the inventive device ages slowly, with the result that its service life corresponds to that of a conventional internal combustion engine, and exchanging the particle filter is generally no longer required. By using a housing or an inner coating of porous silicon carbide, this material represents a suitable heat reservoir. Even in the case of alternating load operation during a phase of minimal engine workload accompanied by a low exhaust gas temperature, stored thermal energy can be conveyed to the first to sixth structures, so that constant passive regeneration of the filtered particles or other residue is continuously possible.

### DESCRIPTION OF THE DRAWINGS

Further characteristics and advantages of the device described herein will emerge from the following description, in which preferred embodiments of the device are explained by way of the schematic illustrations, and in which:

FIG. 1 is a schematic cross-sectional view of an embodiment of the inventive device;

FIG. 2 is a schematic cross-sectional view of an alternative embodiment of the inventive device;

FIG. 3 is a schematic cross-sectional view of a further alternative embodiment of the inventive device; and

FIG. 4 is a schematic cross-sectional view of a further alternative embodiment of the inventive device.

### DETAILED DESCRIPTION

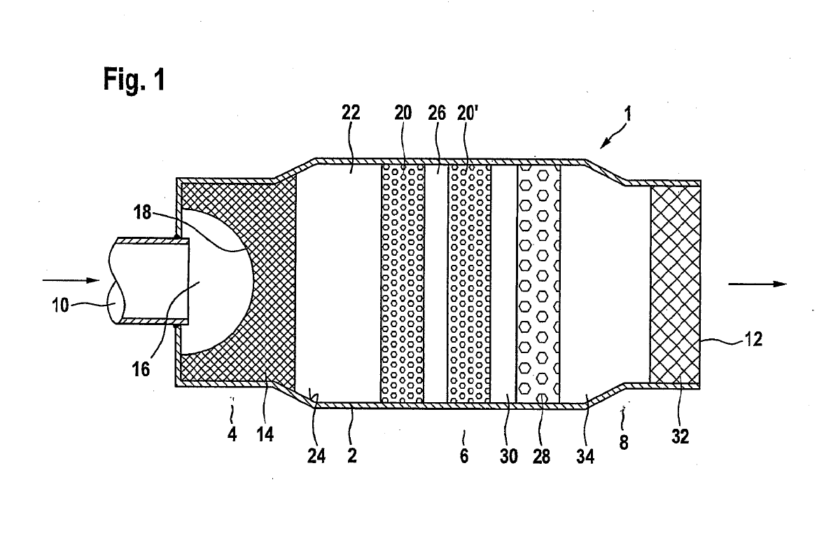

FIG. 1 shows an inventive device 1 for removing contaminants from exhaust gases of internal combustion engines, comprising a housing 2 with a front 4, middle 6, and rear area 8. Arranged in the front area 4 is an intake 10 and in the rear area 8 an outlet 12. Following the intake 10 in the front area 4 of the housing 2 is a first structure 14 made of a material normally used for pore burners. An intake area 16 connected to the intake 10 is itself free of the pore burner structure 14. The surface 18 of the pore burner structure 14 facing the intake 10 rather encloses the intake area 16 approximately semi-spherically. The first structure 14 is chiefly in the front area 4 of the inventive device 1 and covers the entire inner cross-section of the housing 2. The housing diameter widens out perceptibly in the transition area between the front 4 and the middle area 6. The pore burner structure 14 facilitates the laminar flow of the exhaust gas entering the device 1 and eliminates transversal currents, which is why soot particles no longer accumulate on the inner walls 24 of the device 1. Uniform distribution of the contaminants in the exhaust gas flow is also ensured.

Connected to the pore burner structure 14, separated by a first interstice 22, is a second structure 20 comprising a metallic foam extending over the entire cross-section of the middle area 6 of the housing 2, which is coated with potassium vanadate. Following the second structure 20, separated by a second interstice 26, is a further second structure 20′, which substantially matches the second structure 20 in construction and coating, i.e., this is likewise a metallic foam coated with potassium vanadate extending over the entire cross-sectional area of the middle area 6 of the device 1. The purpose of the second structures 20 and 20′ is substantially to convert nitrogen oxide contained in the exhaust gas by means of reduction into harmless constituents.

The middle area 6 is substantially enclosed by a third structure 28, based on a metallic foam, which is coated with a palladium/silver catalyst and serves to oxidize carbon monoxide and hydrocarbons. The third structure 28 again extends over the entire cross-sectional area of the housing 2 and is separated from the second structure 20′ by a third interstice 30, such that there is substantially no direct contact.

Arranged in the rear area 8 of the housing 2 is a fourth structure 32, again based on a metallic foam, which extends over the entire cross-sectional area of the rear area and is coated with a mix of aluminum oxide and cerium oxide. In the illustrated embodiment, the fourth structure 32 is separated from the third structure 28 by a fourth interstice 34. The inner walls 24 of the housing 2 in the illustrated embodiment have a silicon carbide coating.

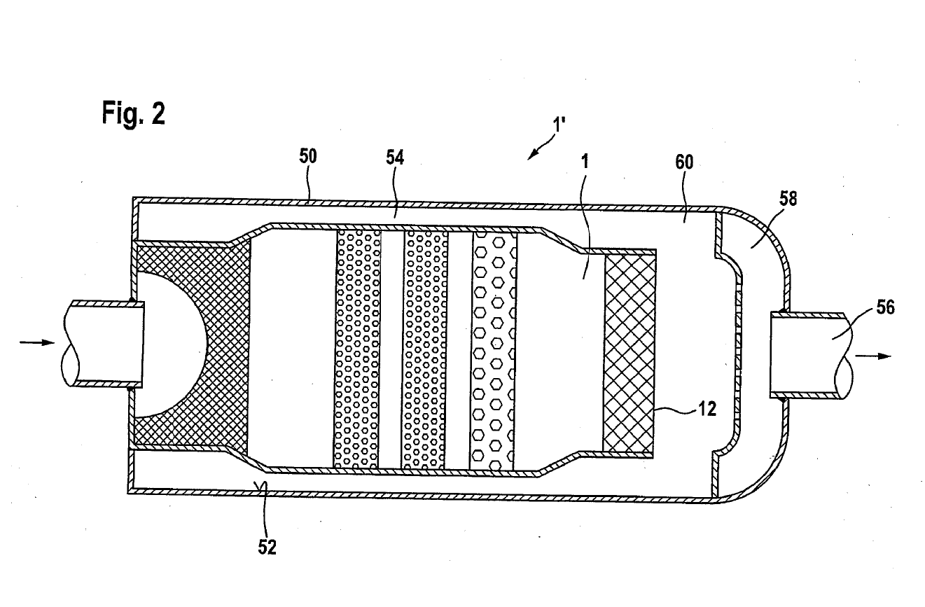

FIG. 2 provides a further view of the exhaust gas purification device 1 described in FIG. 1. In this embodiment 1′ the device 1, as illustrated by FIG. 1 and as described earlier, is enclosed in a further second housing 50. This second housing 50 is attached in the front area 4 to the first housing 2. Apart from that, the device 1 is substantially contact-free in the second housing 50. There is accordingly at least one fifth interstice 54 between the outer wall of the first housing 2 and the inner walls 52 of the outer, second housing 50. It is understood that the device 1 can be supported in the outer housing 50 at one or more points, for example, in the middle or preferably rear area 8 on the inner walls 52.

The outer housing 50 has an outlet 56, which is arranged substantially in front of the outlet 12 of the device 1. Between the outlet 12 and the outlet 56 a pin diaphragm 58 is arranged. The purified exhaust gas exiting from the outlet 12 is consequently hindered by the pin diaphragm 58 from free exit and, depending on the size of the discharge area at least partially in the area 60 lying in front of the outlet 12, is deflected in the direction of the space 54 lying between the device 1 and the inner walls 52 of the outer second housing 50. The temperature of the discharging purified exhaust gas can be used in this way to ensure a constantly high work temperature of the exhaust gas purification device 1.

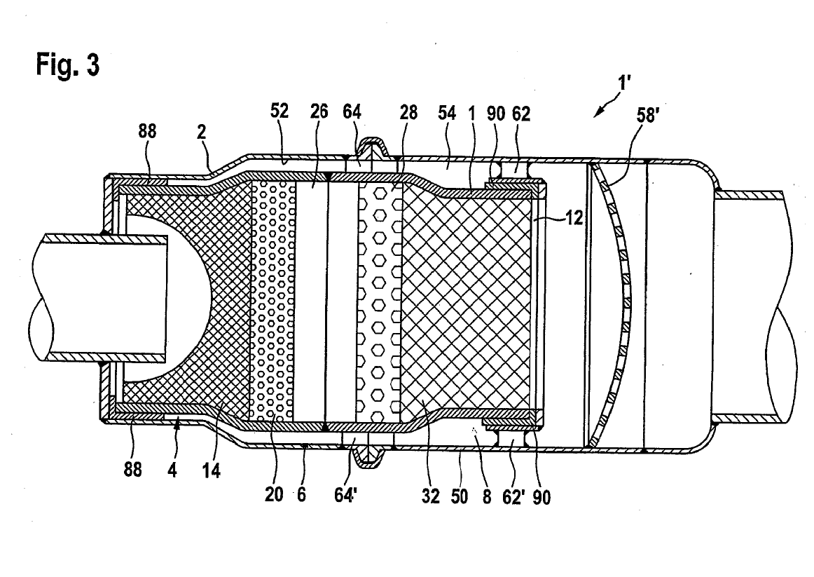

FIG. 3 shows a further embodiment of an inventive device, which is substantially a further development of the device 1′ illustrated in FIG. 2. The exhaust gas purification device 1 is again embedded in an outer housing 50. Located in the front area 4 is the first structure 14 made of a pore burner material. Attached to this now directly is a second structure 20, as described in FIG. 1, with the first interstice 22 omitted. An interstice 26 is then present between the second and third structure 20, 28. The third structure 28 also corresponds here to the variant described in FIG. 1. The fourth structure 32, which is a metallic foam coated with aluminum oxide and cerium oxide, is again connected to the third structure 28, with an interstice 34 omitted. While the second and the third structure 20, 28 are in the middle area 6 of the device 1, the fourth structure 32 substantially completely fills out the rear area 8 of the device 1. Between the inner walls 52 of the outer, second housing 50 and the walls 2 of the first housing 2 of the device 1 is an interstice 54 for accommodating the exhaust gases escaping from the outlet 12. For improved storage, the device 1 in the present case is in contact with the inner walls 52 of the outer housing 50 in the middle and rear area 6 and 8, and via corresponding connecting elements or support bearing 62, 62′ and 64, 64′, for example, made of metal. Between the support bearing 62, 62′ and the outer walls of the first housing 2, for the purpose of better and easier connection and for damping purposes, is a fiber layer 90 containing ceramic fibers and if required a binder. In the front area 2 in the range of the intake 10 there is a fiber layer containing ceramic fibers and if required a binder, as second connecting element 88 between first and second housing. Arranged after the outlet 12 of the device 1 in the second housing 50 is a pin diaphragm 58′, extending over the entire cross-sectional area in the rear area of the housing.

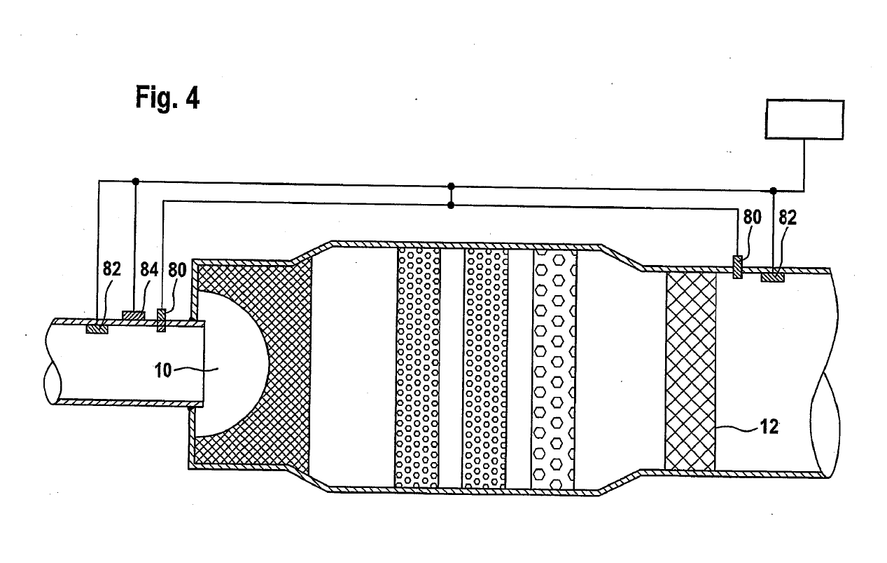

FIG. 4 shows a further development of the device 1 illustrated in FIG. 1. This further development is fitted in the region of the intake 10 and the outlet 12 with temperature and/or pressure sensors 80, 82. In addition, in front of the intake 10 there is a lambda probe 84, with which the oxygen content of the incoming exhaust gas can be determined. The values recorded by these sensors are forwarded to an evaluation unit 86 and are used, for example, for optimized operation of the internal combustion engines.

The characteristics of the device disclosed in the above description, in the diagrams and in the claims can be implemented in any combination for carrying out the device in its various embodiments.

### LIST OF REFERENCE NUMERALS

1, 1′ device for removing harmful constituents from exhaust gases of internal combustion engines
2 first housing
4 front area of the first housing
6 middle area of the first housing
8 rear area of the first housing
10 intake of the first housing
12 outlet of the first housing
14 first structure
16 section in the front area 4 free of the first structure 14
18 front surface of the first structure 14
20, 20′ second structure
22 first interstice
24 inner walls of the first housing 2
26 second interstice
28 third structure
30 third interstice
32 fourth structure
34 fifth interstice
50 second housing
52 inner walls of the second housing
54 sixth interstice
56 outlet of the second housing
58, 58′ retainer
60 area between outlet 12 and retainer 58
62, 62′ rear support bearing (first connecting element)
64, 64′ middle support bearing (first connecting element)
80 temperature sensor
82 pressure sensor
84 lambda probe
86 evaluation unit
88 second connecting element
90 fiber layer containing ceramic fibers

While illustrative embodiments have been illustrated and described, it will be appreciated that various changes can be made therein without departing from the spirit and scope of the invention.

1. A device for removing harmful constituents from exhaust gases of internal combustion engines, comprising:
a first housing for conducting exhaust gases therethrough, the first housing having at least one intake and at least one outlet and containing a front, middle and rear area with at least one intake in the front area and at least one outlet in the rear area, wherein in the front area a first structure containing a plurality of contiguous cavities covers a cross-section of the first housing at least partially, and wherein the following are disposed in the first housing in any sequence:
a second structure covering the cross-section of the first housing at least partially and comprising a plurality of contiguous cavities, the second structure containing and/or is coated with at least one first metal oxide at least partially;
a third structure covering the cross-section of the first housing at least partially and comprising a plurality of contiguous cavities, the third structure containing and/or is coated with at least one catalyst for converting or degrading contaminants at least partially; and
a fourth structure covering the cross-section of the first housing at least partially and comprising a plurality of contiguous cavities, the fourth structure containing and/or is coated with at least one second metal oxide at least partially,
wherein a section or an inner wall of the first housing is made at least partially of aluminum oxide, mullite, cordierite, silicon nitride, tialite, steatite, zircon, zircon dioxide and/or silicon carbide, or is coated with aluminum oxide, mullite, cordierite, silicon nitride, tialite, steatite, zircon, zircon dioxide and/or silicon carbide.

2. The device as claimed in claim 1, wherein the first housing has at least one first, at least one second, at least one third and at least one fourth structure disposed sequentially from the intake to the outlet.

3. The device as claimed in claim 1, wherein a section or an inner wall of the first housing is made at least partially of porous aluminum oxide, mullite, cordierite, silicon nitride, tialite, steatite, zircon, zircon dioxide and/or silicon carbide, or is coated with porous aluminum oxide, mullite, cordierite, silicon nitride, tialite, steatite, zircon, zircon dioxide and/or silicon carbide.

4. The device as claimed in claim 1, wherein an inner wall of the first housing is made up of more than 50% of porous silicon carbide or is coated with porous silicon carbide.

5. The device as claimed in claim 1, wherein the silicon carbide comprises carbon fiber-reinforced silicon carbide.

6. The device as claimed in claim 1, wherein the silicon carbide includes, at least one additive.

7. The device as claimed in claim 1, further comprising a fifth structure covering the cross-section of the first housing at least partially and comprising a plurality of contiguous cavities, wherein the fifth structure contains platinum and/or rhodium, and/or is coated with platinum and/or rhodium at least partially.

8. The device as claimed in claim 7, further comprising a sixth structure covering the cross-section of the first housing at least partially and comprising a plurality of contiguous cavities, wherein the sixth structure contains at least one selective catalytic reduction catalyst and/or is coated with the at least one selective catalytic reduction catalyst at least partially.

9. The device as claimed in claim 8, wherein the first, second, third, fourth, fifth, and/or sixth structure includes an open-pore or open-cell foam ceramic, an open-pore or open-cell metallic foam, an open-pore or open-cell metallic sponge, a heat-resistant open-pore or open-cell foam synthetic, a wire mesh, and/or a sintered bulk material.

10. The device as claimed in claim 1, wherein the first structure is coated at least partially with aluminum oxide and/or titanium oxide.

11. The device as claimed in claim 1, wherein the first metal oxide is vanadate, potassium vanadate, or silver vanadate.

12. The device as claimed in claim 1, wherein the second structure has in addition to the first metal oxide at least one metal nitrate and/or at least one water glass compound.

13. The device as claimed in claim 1, wherein the third structure contains a palladium/silver catalyst and/or is coated with a palladium/silver catalyst.

14. The device as claimed in claim 1, wherein the at least one catalyst comprises iron, nickel, iron oxide and/or nickel oxide, and/or is coated with iron, nickel, iron oxide, and/or nickel oxide.

15. The device as claimed in claim 1, wherein the fourth structure contains aluminum oxide, cerium oxide, and/or zeolites, and/or is coated with aluminum oxide, cerium oxide, and/or zeolites.

16. The device as claimed in claim 1, wherein the front area of the first housing widens out to the middle area, and/or the rear area tapers conically to the outlet.

17. The device as claimed in claim 1, wherein a surface of the first structure, facing the intake is spherically arched in the direction of an interior of the first housing.

18. The device as claimed in claim 1, further comprising a second housing in which the first housing is arranged at least partially, and having a circumferential connection in the front or middle area of the first housing.

19. The device as claimed in claim 18, wherein the intake of the first housing is outside the second housing, and the outlet of the first housing is inside the second housing.

20. The device as claimed in claim 18, wherein an inner wall of the second housing and an outer wall of the first housing are spaced apart at least partially.

21-26. (canceled)

27. The device as claimed in claim 1, further comprising at least two sequential, second structures.

28. The device as claimed in claim 27, wherein between the first and second structure there is a first interstice, between adjacent second structures there is a second interstice, between the second and third structure there is a third interstice, between adjacent third structures there is a fourth interstice, and/or between the third and fourth structure there is a fifth interstice.

29. The device as claimed in claim 7, wherein the fifth structure is arranged between the first and second structure, and is disposed directly adjacent to the first structure.

30. The device as claimed in claim 8, wherein the sixth structure is disposed between the intake and the outlet adjacent to the fourth structure.

31-36. (canceled)

37. A method of using the device of claim 1 for purifying exhaust gases of internal combustion engines on ships, private vehicles, trucks, stationary combustion units, and/or tractors.
